(19) United States
(12) Patent Application Publication
(10) Pub. No.: US 2014/0130032 A1
(43) Pub. Date: May 8, 2014

(54) METHOD AND APPARATUS FOR MANAGING APPLICATION UPDATE INFORMATION IN AN ELECTRONIC DEVICE

(71) Applicant: Samsung Electronics Co., Ltd., Gyeonggi-do (KR)

(72) Inventors: Maciej LIPINSKI, Rybnik (PL); Mikolaj MALECKI, Lomza (PL)

(73) Assignee: Samsung Electronics Co., Ltd., Gyeonggi-do (KR)

(21) Appl. No.: 14/071,853

(22) Filed: Nov. 5, 2013

(30) Foreign Application Priority Data
Nov. 5, 2012 (KR) 10-2012-0124432

(51) Int. Cl. G06F 9/445

(52) U.S. Cl. CPC G06F 8/65
USPC 717/171

(57) ABSTRACT

An electronic device system updates at least one application, collects update information of the at least one updated application and displays the collected update information of the at least one application.

### CLAIM OF PRIORITY

This application claims the benefit under 35 U.S.C. §119(a) of a Korean patent application filed in the Korean Intellectual Property Office on Nov. 5, 2012 and assigned Serial No. 10-2012-0124432, the entire disclosure of which is hereby incorporated by reference.

### BACKGROUND

1. Technical Field

The present invention concerns a system for managing information identifying updates made to executable applications in an electronic device.

2. Related Art

An electronic device such as a smartphone, notebook or computer provides various services using executable applications. An electronic device may correct an error or update a function of an application by performing software update using an update file provided from an external server. An electronic device temporarily displays added or changed update information regarding an application update for each application. For example, upon initial execution of an updated application, an electronic device temporarily displays update information added or changed via a software update. However, a user of the electronic device may not recognize update information and feel uncomfortable or insecure in using the updated application causing user inconvenience and impairing device operability. A system according to invention principles addresses these deficiencies and related problems.

### SUMMARY

An aspect of the present invention is to address at least the above-mentioned problems and/or disadvantages and to provide at least the advantages described below. Accordingly, an aspect of the present invention is to provide an apparatus and a method for updating software in an electronic device.

Another aspect of the present invention is to provide an apparatus and a method for displaying software update information in an electronic device.

Still another aspect of the present invention is to provide an apparatus and a method for managing software update information of at least one application using a separate application in an electronic device.

Yet another aspect of the present invention is to provide an apparatus and a method for reconfiguring a configuration list updated by software update in response to user input information in an electronic device.

A method used by an electronic device comprises updating at least one application, collects update information of the at least one updated application and displays the collected update information of the at least one application.

A method used by an electronic device comprises updating at least one executable application in response to acquired application update data and using a first application for acquiring update information of the at least one updated application identifying individual features updated of individual executable applications. The method collects the acquired update information to indicate features updated of corresponding respective individual executable applications and displays the collected, acquired update information of the at least one executable application.

In a feature of the invention, the update information comprises at least one of, configuration list change information of the application and function addition information of a corresponding respective individual executable application. The updating comprises updating at least one executable application using an update file provided from an external server. Further, in response to selection of a displayed icon of the first application, the method displays the update information of the at least one executable application acquired via the first application. The method displays the update information of the at least one executable application acquired via the first application using a notice bar. In response to displaying the update information of the at least one executable application, the method reconfigures a configuration list of the updated at least one executable application according to input information detected via an input unit and displays a configuration list tree for the updated at least one executable application and also reconfigures the configuration list regarding the updated at least one executable application according to the input information detected via the input unit.

The method determines whether at least one executable application to which a new function has been added exists among the updated at least one executable application, and displays the configuration list tree by in response to determination the at least one executable application to which the new function has been added exists, displaying a configuration list tree for the at least one executable application to which the new function has been added. In response to determination the at least one executable application to which the new function has been added does not exist, displaying a message indicating the configuration list is unavailable.

In a feature of the invention, the electronic device comprises a display unit, at least one processor, a memory and a program stored in the memory and executed by the at least one processor. The processor updates at least one application, collects update information of the at least one updated applications and displays on the display unit the collected update information of the at least one application.

In a feature of the invention, the electronic device comprises a display unit, at least one processor, a memory and a program stored in the memory and executed by the at least one processor. The processor updates at least one executable application in response to acquired application update data, uses a first application for acquiring update information of the at least one updated application identifying individual features updated of individual executable applications, collects the acquired update information to indicate features updated of corresponding respective individual executable applications and displays on the display unit the collected, acquired update information of the at least one executable application.

In another feature of the invention, a method used by an electronic device updates at least one executable application in response to acquired application update data and uses a first application for acquiring update information of the at least one updated application identifying individual features updated of individual executable applications. The method collects the acquired update information to indicate features updated of corresponding respective individual executable applications and in response to input information detected via an input unit, reconfigures a configuration list of the updated at least one executable application. The method displays the reconfigured configuration list.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 shows a block diagram of an electronic device according to an embodiment of the present invention;

FIG. 2 shows a detailed block diagram of a processor according to an embodiment of the present invention;

FIG. 3 shows a flowchart of a procedure for displaying update information in an electronic device according to an embodiment of the present invention;

FIG. 4 shows a flowchart of a procedure for displaying update information in an electronic device according to an embodiment of the present invention;

FIG. 5 shows a flowchart of a process for changing configuration of application update information in an electronic device according to an embodiment of the present invention;

FIGS. 6A and 6B show displayed images presenting update information in an electronic device according to an embodiment of the present invention; and

FIGS. 7A, 7B and 7C show further displayed images presenting update information in an electronic device according to an embodiment of the present invention.

Throughout the drawings, like reference numerals will be understood to refer to like parts, components and structures.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

Exemplary embodiments of the present invention provide a technology for managing application update information in an electronic device. In other words, the present invention describes a technology for displaying and updating change information of an application configuration list in response to a software update in an electronic device.

In the following description, the electronic device may be a portable electronic device, a portable terminal, a mobile communication terminal, a Personal Digital Assistant (PDA), a laptop computer, a smartphone, a netbook, a television (TV), a Mobile Internet Device (MID), an Ultra Mobile Personal Computer (UMPC), a tablet PC, a desktop computer, a smart TV, a digital camera, a wrist watch, a navigation, an MP3 player, for example. Also, the electronic device may be a combined electronic device that combines functions of two or more devices among these devices.

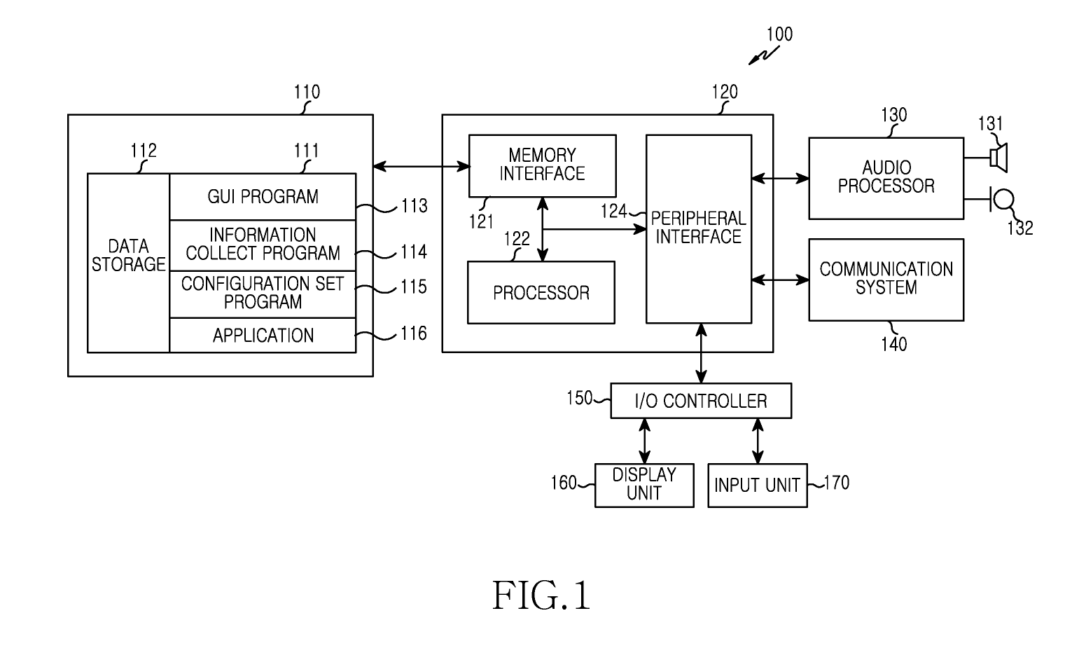

FIG. 1 shows a block diagram illustrating an electronic device 100 according to an embodiment of the present invention.

As illustrated in FIG.1, the electronic device 100 includes at least one memory 110, a processor unit 120, an audio processor 130, a communication system 140, an Input/Output (I/O) controller 150, a display unit 160, and an input unit 170. The memory 110 includes program storage 111 for storing a program for controlling an operation of the electronic device 100, and a data storage 112 for storing data occurring during execution of a program.

The data storage 112 stores update information of each application collected via an information collect program 114.

The program storage 111 may include a Graphic User Interface (GUI) program 113, an information collect program 114, a configuration set program 115, and at least one application 116. A program in the program storage 111 is a set of instructions, and may be expressed as an instruction set.

The GUI program 113 includes at least one software element for providing a user interface using graphics via the display unit 160. For example, the GUI program 113 controls display application information presented by the processor 122 on the display unit 160. For another example, the GUI program 113 controls display of update information of each application on the display unit 160 under control of the information collect program 114.

The information collect program 114 includes at least one software element for collecting software update information regarding each application. For example, in response to a configuration list of a first application being changed via software update, the information collect program 114 collects change information of the first application. The information collect program 114 receives application change information from the first application in response to a configuration list change. For another example, in response to a new function being added to the first application via software update, the information collect program 114 collects additional function information of the first application. The information collect program 114 receives additional function information from the first application in response to the new function add.

Also, the information collect program 114 includes at least one software element for controlling display of update information of each application. For example, in response to occurrence of an update information display event, the information collect program 114 controls the GUI program 113 to display collected update information of each application and may delete update information of an application displayed on the display unit 160 from an update information collect list.

The configuration set program 115 includes at least one software element for reconfiguring a configuration list of applications changed via software update. For example, in response to a new function being added to the first application via software update, the configuration set program 115 changes the position of the newly added function in a configuration list of the first application depending on input information detected via the input unit 170 and reconfigures the configuration list of the first application in response to the input information detected via the input unit 170. A configuration list as used herein comprises a hierarchical tree type list or other list of the executable software elements and data comprising an executable application configuration including, program portions, subroutines, linked elements, library elements, stored data, links to external routines, external routines and interfaces.

The application 116 includes a software element of at least one application installed in the electronic device 100. The application 116 performs software update using an update file provided from a communication system 140 or an external interface that comprises a Universal Serial Bus (USB), for example, as a connection interface with other devices.

The processor unit 120 includes a memory interface 121, at least one processor 122, and a peripheral interface 124 that are integrated in at least one integrated circuit (IC) or are implemented as separate elements.

The memory interface 121 controls access to the memory 110 by processor 122 or the peripheral interface 124.

The peripheral interface 124 controls connection between I/O peripherals of the electronic device 100 and the processor 122 and the memory interface 121. The processor 122 controls the electronic device 100 to provide various multimedia services using at least one software program. The processor 122 executes at least one program stored in the memory 110 to provide a service.

The audio processor 130 provides an audio interface between a user and the electronic device 100 via a speaker 131 and a microphone 132.

The communication system 140 performs a communication function for voice communication and data communication. For example, the communication system 140 may receive an update file for updating software from an external server.

The communication system 140 may be divided into a plurality of communication submodules supporting different communication networks. For example, though not limited thereto, the communication network may include a GSM network, an EDGE network, a CDMA network, a W-CDMA network, an LTE network, an OFDMA network, a wireless LAN, a Bluetooth network, an NFC, for example.

The I/O controller 150 provides an interface between I/O units such as the display unit 160 and the input unit 170, and the peripheral interface 124.

The display unit 160 displays state information of the electronic device 100, text input by a user, moving pictures, still pictures, for example. Further, the display unit 160 displays information of an application executed by the processor 122 and displays update information of each application collected via the information collect program 114 under control of the GUI program 113.

The input unit 170 provides input data generated by user selection to the processor unit 120 via the I/O controller 150. The input unit 170 includes a keypad including at least one hardware button and a touch pad for detecting touch information, for example.

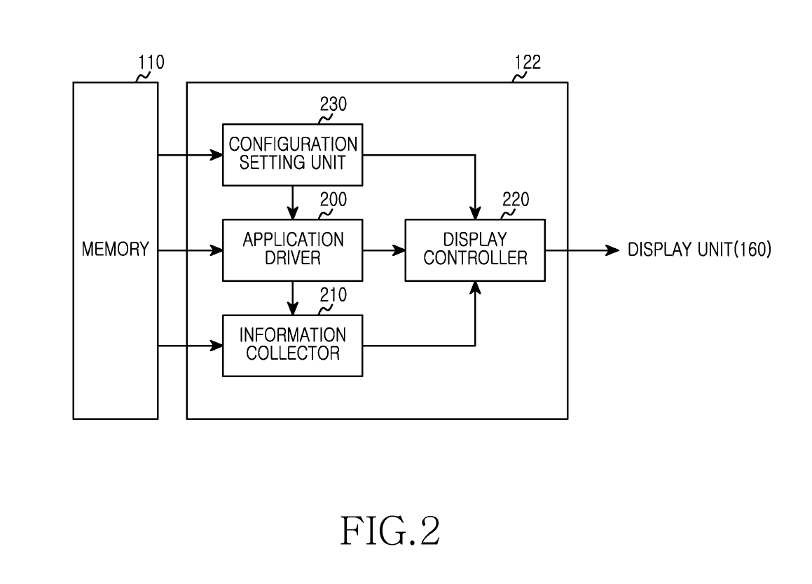

FIG. 2 shows a detailed block diagram illustrating processor 122 according to an embodiment of the present invention.

As illustrated in FIG. 2, the processor 122 includes an application driver 200, an information collector 210, a display controller 220, and a configuration setting unit 230. The application driver 200 executes at least one application 116 stored in the program storage 111 to provide a service. Also, the application driver 200 updates the application using an update file provided via the communication system 140 or an external interface.

The information collector 210 executes the information collect program 114 stored in the program storage 111 to collect update information of each application software update. For example, where in response to change in a configuration list of the first application resulting from software update, the information collector 210 collects change information of the first application from the application driver 200. For another example, in response to a new function being added to the first application via software update, the information collector 210 collects additional function information of the first application from the application driver 200.

Also, the information collector 210 includes at least one software element for controlling display of update information of each application. For example, where an icon of the information collect application is selected, the information collector 210 may control the display controller 220 to display update information of each application. At this time, the information collector 210 may delete update information of an application displayed on the display unit 160 from an update information collect list in response to command.

The display controller 220 controls execution of the GUI program 113 stored in the program storage 111 and displays the graphical user interface via the display unit 160. For example, the display controller 220 controls to display information of an application driven by the application driver 200 on the display unit 160. For another example, the display controller 220 may control to display update information of each application on the display unit 160 under control of the information collector 210.

The configuration setting unit 230 executes the configuration set program 115 stored in the program storage 111 to reconfigure a configuration list of an application changed via software update. For example, in response to a new function being added to the first application via software update, the configuration setting unit 230 changes reconfigures the configuration list by changing the position of the newly added function in the configuration list of the first application depending on input information detected via the input unit 170.

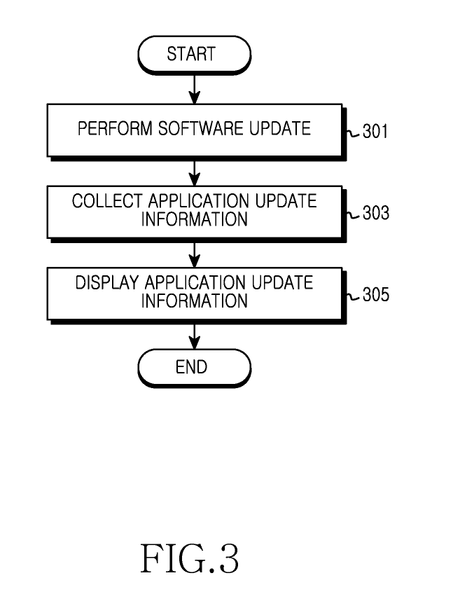

FIG. 3 shows a flowchart of a process for displaying update information in an electronic device according to an embodiment of the present invention.

Referring to FIG. 3, the electronic device performs software update on an application in step 301. For example, the electronic device may perform the software update on at least one application with consideration of an update file provided from an external server via the communication system 140 or an external interface.

In step 303 the electronic device collects update information of each application software update (e.g. in response to detecting change in an application or configuration list). In response to a configuration list of the first application being changed via software update, the electronic device collects change information of the first application using the information collect program 114. The information collector 210 receives software update change information of the first application from the application driver 200. In response to a new function being added to the first application via software update, the electronic device collects additional function information of the first application using the information collect program 114. The information collector 210 receives additional function information of the first application from the application driver 200.

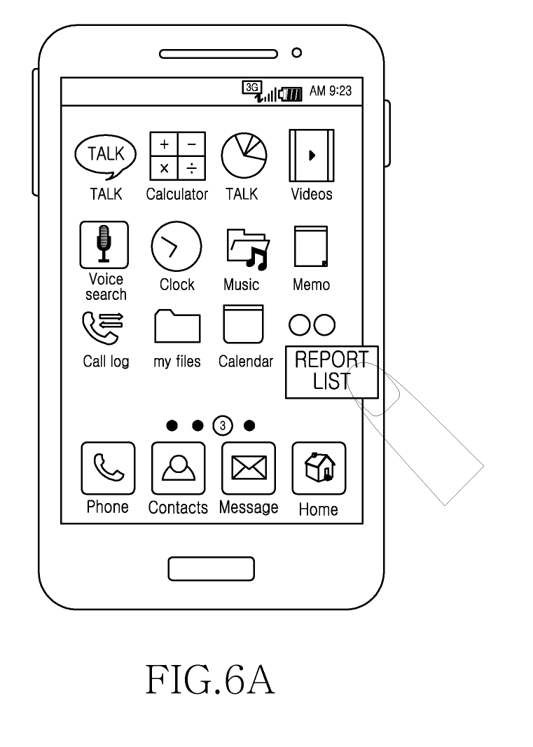

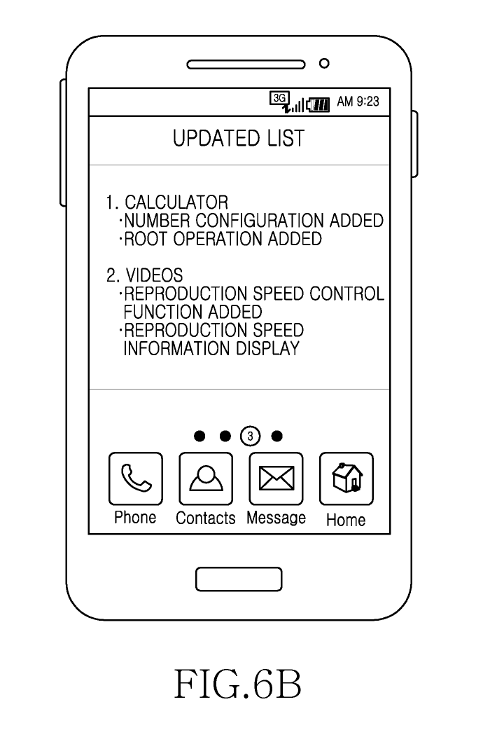

In step 305 the electronic device displays update information of the application collected in step 303 on the display unit 160 in response to a type of update information display event. For example, as illustrated in FIG. 6A, in the case where an icon “report list” for the information collect application is selected, the electronic device displays update information of an application “calculator” and an application “video” which are software-updated as illustrated in FIG. 6B. The electronic device sorts and displays update information of each application in response to at least one of a software update sequence, an application name sequence, and an application use frequency. The electronic device collects the acquired update information to indicate features updated of corresponding respective individual executable applications. The electronic device may collect update information in one embodiment by application alphabetically, by application recentness of use, by application frequency of use or by a predetermined application priority, for example.

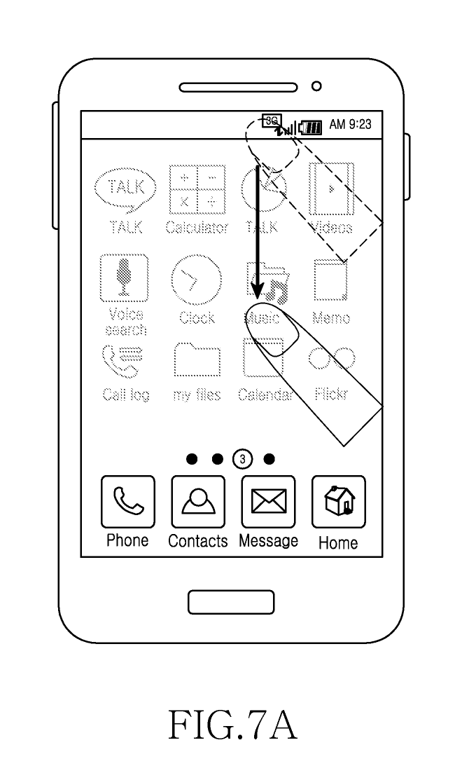

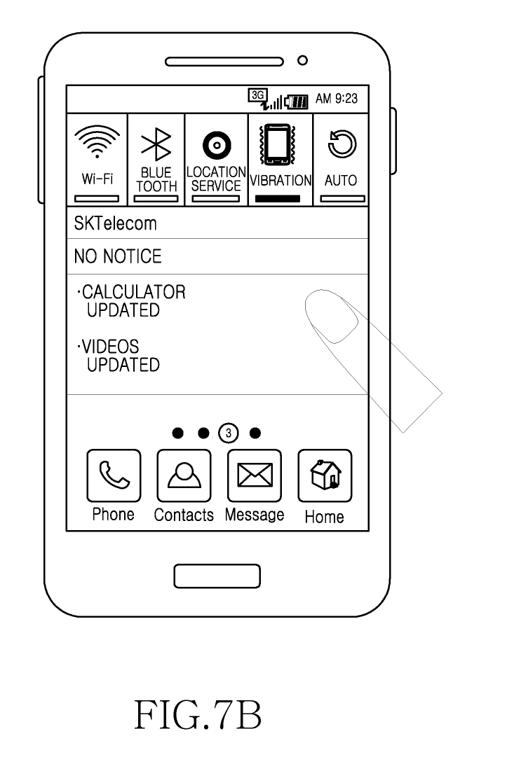

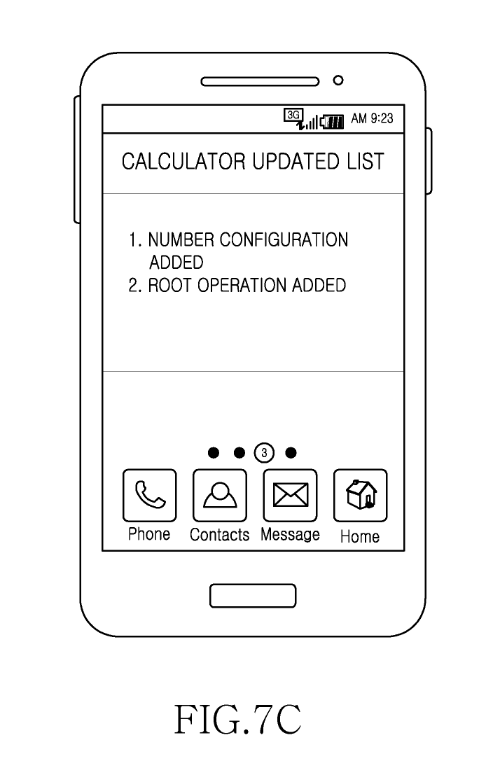

For another example, as illustrated in FIG. 7A, when detecting a drag in the downward direction, the electronic device displays a notice bar including update information of an application “calculator” and an application “video” which have had a software-update as illustrated in FIG. 7B. In response to an application “calculator” being selected from a list of applications on which software update has been performed, the electronic device displays update information of the software-updated application “calculator” as illustrated in FIG. 7C.

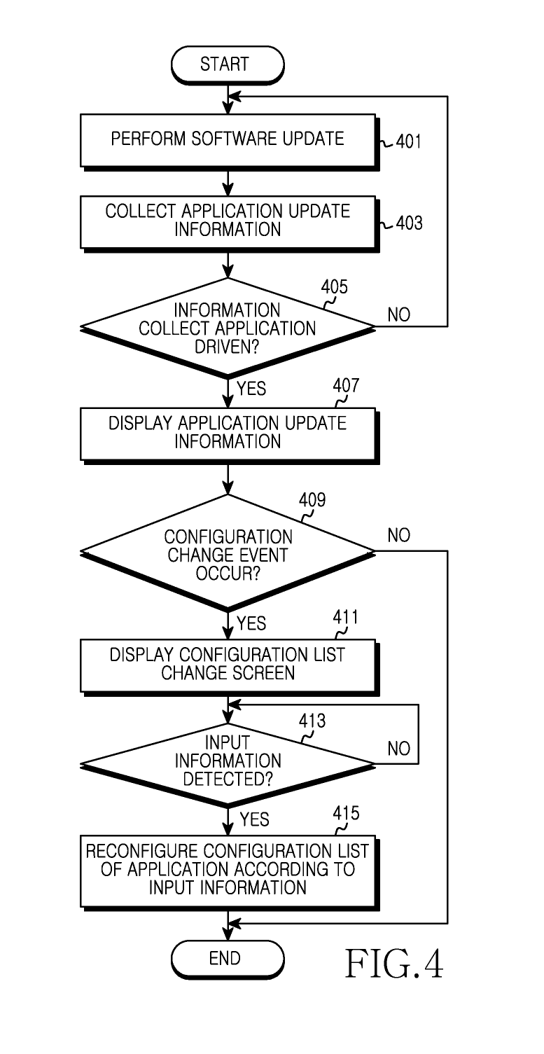

FIG. 4 shows a flowchart of a procedure for displaying update information in an electronic device according to an embodiment of the present invention.

As illustrated in FIG. 4, the electronic device performs software update on an application in step 401. For example, the electronic device may perform the software update on at least one application with consideration of an update file provided from an external server via the communication system 140 or the external interface.

In step 403 the electronic device collects update information of each application software update. In response to a configuration list of the first application being changed via software update, the electronic device collects change information of the first application using the information collect program 114. The information collector 210 receives software update change information of the first application from the application driver 200. In response to a new function being added to the first application via software update, the electronic device collects additional function information of the first application using the information collect program 114. The information collector 210 receives additional function information of the first application from the application driver 200.

In step 405 the electronic device determines whether an update information display event occurs. For example, as illustrated in FIG. 6A, the electronic device determines whether an icon “report list” for an information collect application is selected. Also, as illustrated in FIG. 7A, the electronic device determines whether a drag for displaying a notice bar is detected. Further, the electronic device determines whether an update information display event occurs in response to user gesture detected via a sensing module.

If an update information display event does not occur, the electronic device processing returns to step 401 to determine whether to perform software update.

If an update information display event occurs, in step 407, the electronic device displays the update information of the application collected in step 403 on the display unit 160. For example, as illustrated in FIG. 6A, in the case where an icon “report list” for the information collect application is selected, the electronic device displays update information of an application “calculator” and an application “video” which are software-updated as illustrated in FIG. 6B. The electronic device sorts and display update information of each application in response to at least one of, a software update sequence, an application name sequence, and an application use frequency. As illustrated in FIG. 7A, in response to detecting a drag in a downward direction, the electronic device displays a notice bar including update information of an application “calculator” and an application “video” which have been updated as illustrated in FIG. 7B, wherein response to an application “calculator” being selected from a list of applications on which software update has been performed and as indicated in a notice bar, the electronic device displays update information of the software-updated application “calculator” as illustrated in FIG. 7C.

In step 409 the electronic device determines whether a configuration change event occurs. For example, the electronic device may determine whether a configuration change menu is selected. For another example, the electronic device may determine whether a configuration change event occurs in response to a user gesture detected via a sensing module.

If a configuration change event does not occur, the electronic device ends the FIG. 4 process. The electronic device may alternatively delete update information of the application displayed on the display unit 160 in response to an update information display event from the update information collect list.

If a configuration change event occurs, in step 411, the electronic device displays a configuration list change screen. For example, the electronic device displays a hierarchical configuration list tree of an application to which a new function has been added via software update on the display unit 160.

In step 413 the electronic device determines whether user input information is detected via the input unit 170

If user input information is detected, in step 415, the electronic device updates the configuration list of the application depending on the user input information. The electronic device changes the position of the function newly added via the software update in the configuration list of the application according to the user input information to reconfigure the configuration list of the relevant application and the process of FIG. 4 terminates.

As described above, the electronic device changes the position of the function newly added via the software update to reconfigure the configuration list of the relevant application. Where a configuration change event occurs in step 409, the electronic device may determine whether an application to which a new function has been added via software update exists and in step 411 displays the configuration list change screen for the at least one application to which the new function has been added. Where the at least one application to which a new function has been added via software update does not exist, the electronic device terminates the FIG. 4 process and displays information indicating an application with changed configuration list does not exist.

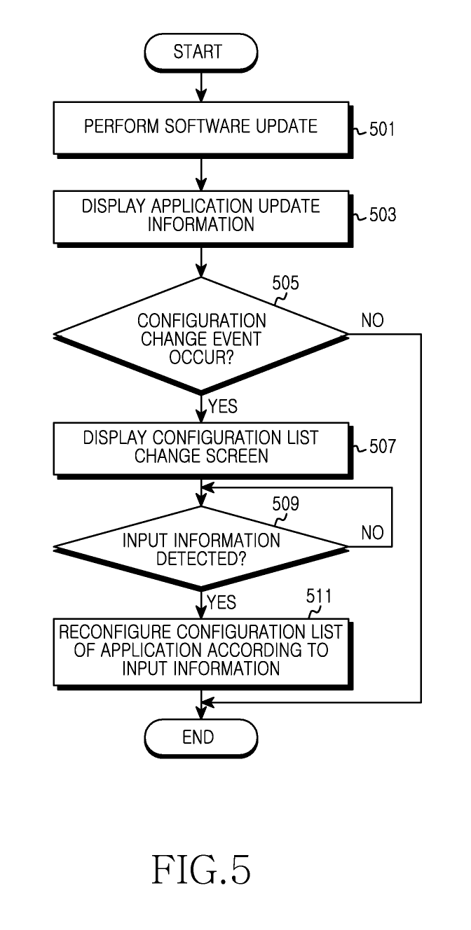

FIG. 5 shows a flowchart of a process for changing configuration of application update information in an electronic device according to an embodiment of the present invention.

Referring to FIG. 5, the electronic device performs software update on the first application in step 501. For example, the electronic device performs the software update on the first application in response to an update file of the first application provided from an external server via the communication system 140 or an external interface.

In step 503, the electronic device displays update information of the first application on the display unit 160, Here, the update information includes at least one of, configuration list change information of the first application and additional function information of the first application.

In step 505, the electronic device determines whether a configuration change event occurs. For example, the electronic device determines, whether a configuration change menu is selected. For another example, the electronic device may determine whether a configuration change event occurs in response to a user gesture detected via a sensing module.

If a configuration change event does not occur, the electronic device terminates the FIG. 5 process.

If a configuration change event occurs, In step 507, the electronic device displays a configuration list change screen. For example, the electronic device displays a hierarchical configuration list tree of the first application to which a new function has been added via software update on the display unit 160.

In step 509, the electronic device determines whether user input information is detected via the input unit 170.

In response to user data entry detection, in step 511, the electronic device updates a configuration list of an application. The electronic device changes the position of a function newly added via the software update in the configuration list of the application in response to user input information and reconfigures the configuration list and the process of FIG. 5 terminates.

As described above, the electronic device may change the position of the function newly added via the software update to reconfigure the configuration list of the application. Accordingly, where a configuration change event occurs in step 505, the electronic device may determine whether a new function has been added to the first application via the software update. If a new function has been added via the software update, the electronic device may proceed to step 507 to display the configuration list change screen of the first application. If a new function has not been added via the software update, the electronic device terminates the FIG. 5 process and display information indicating no change of the configuration list of the first application.

The electronic device advantageously manages software update information of at least one application using a separate application, so that a user may easily and accurately recognize software update information. The electronic device controls reconfiguration of a configuration list updated by software update in response to user input information to facilitate user friendly operation

The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.”

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof

What is claimed is:

1. A method used by an electronic device, the method comprising:
updating at least one application;
collecting update information of the at least one updated application using a first application; and
displaying the collated update information of the at least one application.

2. The method of claim 1, wherein the update information comprises at least one of configuration list change information of the application and function addition information of application.

3. The method of claim 1, wherein the updating comprises updating at least one application using an update file provided from an external server.

4. The method of claim 1, wherein displaying the update information comprises:
in response to selection of a displayed icon of the first application, displaying the update information of the at least one application collected via the first application.

5. The method of claim 1, wherein displaying the update information comprises:
displaying the update information of the at least one application collected via the first application using a notice bar.

6. The method of claim 1, further comprising:
after displaying the update information of the at least one application, reconfiguring a configuration list of the updated at least one application according to input information detected via an input unit.

7. The method of claim 6, wherein the reconfiguring of the configuration list comprises:
displaying a configuration list tree for the updated at least one application; and
reconfiguring the configuration list regarding the updated at least one application according to the input information detected via the input unit.

8. The method of claim 7, further comprising:
determining whether at least one application to which a new function has been added exists among the updated at least one application,
wherein displaying the configuration list tree comprises:
in response to determination the at least one application to which the new function has been added exists, displaying a configuration list tree for the at least one application to which the new function has been added.

9. The method of claim 8, further comprising:
in response to determination the at least one application to which the new function has been added does not exist, displaying a message indicating no change of the configuration list.

10. An electronic device comprising:
a display unit;
at least one processor;
a memory; and
a program stored in the memory and executed by the at least one processor,
wherein the processor updates at least one application, collects update information of the at least one updated applications and displays on the display unit the collected update information of the at least one application.

11. The electronic device of claim 10, wherein the update information comprises at least one of configuration list change information of the application and function addition information of application.

12. The electronic device of claim 10, wherein the processor updates at least one application using an update file provided from an external server.

13. The electronic device of claim 10, wherein in response to selection of a displayed icon of the first application, the processor displays the update information of the at least one application collected via the first application on the display unit.

14. The electronic device of claim 10, wherein the processor displays on the display unit, the update information of the at least one application collected via the first application using a notice bar.

15. The electronic device of claim 10, wherein after displaying the update information of the at least one executable application on the display unit, the processor reconfigures a configuration list of the updated at least one application according to input information detected via an input unit.

16. The electronic device of claim 15, wherein the processor displays a configuration list tree regarding the updated at least one application on the display unit and reconfigures the configuration list regarding the updated at least one application in response to input information.

17. The electronic device of claim 16, wherein the processor determines whether at least one application to which a new function has been added exists among the updated at least one application, and in response to a determination the at least one application to which the new function has been added exists, the processor displays a configuration list tree for the at least one application to which the new function has been added.

18. The electronic device of claim 17, wherein in response to a determination the at least one application to which the new function has been added does not exist, the processor displays a message indicating no change of the configuration list.

19. A method used by an electronic device, the method comprising:
updating at least one executable application in response to acquired application update data;
identifying individual features updated of individual executable applications using a first application for acquiring update information of the at least one updated application;
collecting the acquired update information to indicate features updated of corresponding respective individual executable applications;
reconfiguring a configuration list of the updated at least one executable application; and
displaying the reconfigured configuration list.

20. The method of claim 19, further comprising:
reconfiguring the configuration list in response to input information detected via an input unit.
